(19) United States
(12) Patent Application Publication
(10) Pub. No.: US 2015/0006228 A1
(43) Pub. Date: Jan. 1, 2015

(54) STOCK COVERAGE CALCULATION IN AN OLAP ENGINE

(71) Applicants: Michael Wilking, Zuzenhausen (DE); Stefan Dipper, Wiesloch (DE); Sebastian Schroetel, Heidelberg (DE)

(72) Inventors: Michael Wilking, Zuzenhausen (DE); Stefan Dipper, Wiesloch (DE); Sebastian Schroetel, Heidelberg (DE)

(21) Appl. No.: 13/928,658

(22) Filed: Jun. 27, 2013

(51) Int. Cl. G06Q 10/06

(52) U.S. Cl. CPC G06Q 10/06314
USPC 705/7.24

(57) ABSTRACT

A system includes definition of a time dimension as a formula exception aggregation reference dimension of a stock coverage measure, modification of filters of a demand measure to retrieve demand values outside a time filter of a cell, retrieval of individual values of the demand measure for each value of the time dimension, generation of a table comprising, for each value of a stock measure, values of the demand measure needed to calculate the stock coverage measure, and determination of the stock coverage measure based on the table and on the formula exception aggregation.

### BACKGROUND

Modern business enterprise systems use business data to answer business-related questions. One such question concerns “stock coverage”. Stock coverage is equal to the number of days for which a given amount of product stock will cover forecasted demand for the product. The stock coverage may be calculated in the granularity of any time dimension, not limited to days.

### BRIEF DESCRIPTION OF THE DRAWINGS

FIG. 1 is a block diagram of a system according to some embodiments.

FIG. 2 is a flow diagram of a process according to some embodiments.

FIG. 3 is a representation of an adapted filter for a demand measure according to some embodiments.

FIG. 4 comprises relational representations of input data for a stock coverage calculation according to some embodiments.

FIG. 5 comprises representations of lines of a table storing input values for the calculation of cell values according to some embodiments.

FIG. 6 comprises portions of relations without constant selection on T_{SC} and a table with constant selection on T_{SC} according to some embodiments.

FIG. 7 comprises relational representations of input data for a stock coverage calculation with an exception aggregation reference dimension according to some embodiments.

FIG. 8 comprises representations of lines of relations storing input values for the calculation of cell values according to some embodiments.

FIG. 9 illustrates a stock coverage calculation with exception aggregation according to some embodiments.

FIG. 10 illustrates currency conversion according to some embodiments.

FIG. 11 is a block diagram of a system according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

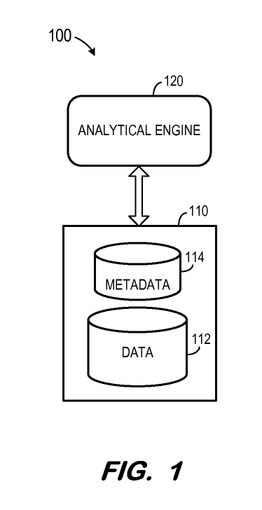

FIG. 1 is a block diagram of system 100 according to some embodiments. System 100 includes database 110 and analytical engine 120.

Database 110 may comprise any query-responsive data source or sources that are or become known, including but not limited to a structured-query language (SQL) relational database management system. Database 110 may comprise a relational database, a multi-dimensional database, an eXtendable Markup Language (XML) document, or any other data storage system storing structured and/or unstructured data. Data 112 of database 110 may be distributed among several relational databases, multi-dimensional databases, and/or other data sources. Embodiments are not limited to any number or types of data sources. For example, database 110 may comprise one or more OnLine Analytical Processing (OLAP) databases (i.e., cubes), spreadsheets, text documents, presentations, etc.

Database 110 may implement an “in-memory” database, in which volatile (e.g., non-disk-based) storage (e.g., Random Access Memory) is used both for cache memory and for storing data 112 during operation, and persistent storage (e.g., one or more fixed disks) is used for offline persistency of data 112 and for maintenance of database snapshots. Alternatively, volatile storage may be used as cache memory for storing recently-used database data, while persistent storage stores data 112. In some embodiments, the data 112 comprises one or more of conventional tabular data, row-based data stored in row format, column-based data stored in columnar format, and object-based data. Database 110 may also or alternatively support multi-tenancy by providing multiple logical database systems which are programmatically isolated from one another. Moreover, data 112 may be indexed and/or selectively replicated in an index to allow fast searching and retrieval thereof.

Database 110 may store metadata 114 describing regarding the structure, relationships and meaning of data 112. This information may include data defining the schema of database tables stored within data 112. A database table schema may specify the name of a database table, columns of the database table, the data type associated with each column, and other information associated with the database table. Metadata 114 may also define a logical schema of dimensions, measures, and properties and their respective logical associations with the database tables.

Dimensions represent sets of values along which an analysis may be performed or a report may be generated (e.g., Country, Year, Product), and measures are indicators, most often numeric, whose values can be determined for a given combination of dimension values. For example, a Sales measure may be used to determine the total sales for January (i.e., a value of the Month dimension) in France (i.e., a value of the Country dimension).

Measures may be used in formulas, in conditions, and in any navigation state of a query. Types of measures may include “basic” measures , “restricted” measures (i.e., measures filtered by one or more dimension values), and “calculated” measures (i.e., measures defined by a formula, which may include one or more measures, constants and operators). Metadata 114 may also define iterative measures as will be described in more detail below.

Analytical engine 120 performs operations on data 112. Analytical engine 120 may comprise an OLAP engine according to some embodiments. Analytical engine 120 may perform such operations in response to queries received from external clients (not shown), such as an analysis client application.

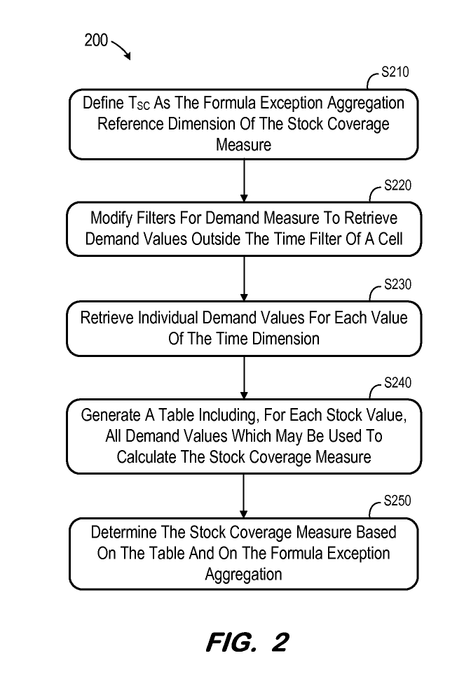

FIG. 2 comprises a flow diagram of process 200 according to some embodiments. In some embodiments, various hardware elements (e.g., processors) of analytical engine 120 execute program code to perform process 200. Process 200 and all other processes mentioned herein may be embodied in processor-executable program code read from one or more of non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Process 200 may be executed to calculate stock coverage based on measures and a time dimension defined in metadata 114. Some embodiments provide efficient stock coverage calculation in an OLAP engine by reusing existing functionality of the engine.

The stock coverage calculation will now be described with reference to the example data below.

| Period | 1 | 2 | 3 | 4 | 5 |
|---|---|---|---|---|---|
| Stock Coverage | 2.5 | | | | |
| Stock | 10 | | | | |
| Demand | | 3 | 4 | 6 | |

A value of the Stock measure can represent stock existing at the beginning of a period or at the end of a period. For period 1 a stock of 10 exists, which is a stock at the end of period 1. Consequently, the first demand to be considered in the stock coverage calculation is the demand of period 2 (i.e., 3).

First, the number of periods for which the demand is fully covered is determined This is the maximum number of periods for which the stock of period 1 is greater than or equal to the cumulated demand of the periods. This calculation may be expressed as follows:

a(t)=max(j|Stock(t)≧Σᵢ₌ₜ₊₁^{t+j}Demand(i))

Considering the above example:

a(1)=2

Next, the covered proportion of the next period's demand is determined. The covered proportion is equal to the stock minus the cumulated demands of the fully-covered periods, divided by the demand of the next period. This determination may be expressed as follows:

$$b ( t ) = \frac{( Stock ( t ) - {\sum }_{i = t + 1}^{t + a ( t )} Demand ( i ) )}{Demand ( t + a ( t ) + 1 )}$$

Again considering the above example:

$$b ( 1 ) = \frac{( 10 - 7 )}{6} = 0.5$$

The stock coverage is equal to the number of the fully-covered periods plus the covered proportion of the next period. In case the stock is less than 0, then the stock coverage is defined as 0. Thus the following:

$$StockCoverage ( t ) = \{ \begin{matrix}a ( t ) + b ( t ) , Stock ( t ) \geq 0 \\ 0 , Stock ( t ) < 0\end{matrix}$$

Therefore, according to the present example:

StockCoverage(1)=2+0.5=2.5

If the stock value represents stock existing at the start of a period, the first demand considered by the stock coverage calculation is in the same period. The formulas to calculate the fully-covered periods a(t) and the covered proportion of the next period b(t) differ from the formulas shown above as follows:

| Period | 1 | 2 | 3 | 4 | 5 |
|---|---|---|---|---|---|
| Stock Coverage | 2.5 | | | | |
| Stock | 10 | | | | |
| Demand | 3 | 4 | 6 | | |

$$\begin{matrix}a ( t ) = max ( j \vert Stock ( t ) \geq {\sum }_{i = t}^{t - 1 + j} Demand ( i ) ) \\ b ( t ) = \frac{( Stock ( t ) - {\sum }_{i = t}^{t - 1 + a ( t )} Demand ( i ) )}{Demand ( t + a ( t ) )}\end{matrix}$$

As mentioned above, metadata 114 includes metadata defining the stock coverage measure. Since, as described above, a Stock measure value can represent stock at the beginning or at the end of a period, the metadata of the Stock Coverage measure defines whether the Stock measure represents a stock at the start or the end of a period.

Specifically, the period t_{DF}, on which the first demand is considered by the stock coverage calculation, is t_{S} (period of the Stock) if the Stock measure represents stock at the start of a period, or t_{S}+1 if the Stock measure represents stock at the end of a period.

The metadata of the Stock Coverage measure further defines a Demand measure, and a time dimension. The time dimension implicitly specifies the granularity of time which is represented by each iteration. Examples include calendar day and calendar month.

In some embodiments, the metadata of the Stock Coverage measure also defines a fixed unit which should match the time dimension T_{SC}. The unit can be defined in the metadata automatically based on the time dimension T_{SC}. This option requires that a mapping between the time dimensions and the corresponding unit of each time dimension exists. Alternatively, the unit can be defined manually, with the user ensuring consistency between the time dimension T_{SC} and unit of the Stock Coverage measure.

As the stock coverage calculation sums up the demand of all covered periods, it could theoretically sum up the demands of an infinite number of periods and thereby consume infinite runtime. To limit the runtime consumed by the stock coverage calculation and to handle the case of an infinite stock coverage, the metadata may specify a maximum number of periods for which demand values are considered.

In some embodiments, process 200 is performed after standard and exception aggregation and currency/unit conversion. In other words, this aggregation and conversion have already been applied to the Stock measure and Demand measure which will be considered by process 200.

According to some embodiments, analytical engine 120 returns, for a given query and navigation state, a table of cells to its caller. Each cell contains a numerical value and additional information about currency, unit and formatting. Analytical engine 120 determines the value of each cell independent of other cells. The value of a cell can be determined based on a formula with multiple operands. Therefore, all necessary operand values need to be available per cell.

At S210 of process 200, time dimension T_{SC} is defined as the formula exception aggregation reference dimension for stock coverage measures. According to some embodiments, the exception aggregation defined for a Stock Coverage measure is not executed during exception aggregation, but is executed as a formula exception aggregation which occurs after the stock coverage calculation and the formula calculation. A formula exception aggregation can be used as operand of another formula in the same way as a measure, formula or formula exception aggregation. Consequently a stock coverage measure can be used in a formula like any other measure or formula or formula exception aggregation.

Next, at S220, filters for the Demand measure are modified to retrieve demand values outside the time filter of a cell. Analytical engine 120 may support multiple types of filters affecting a cell. These filters are applied for all input data of a cell and are modified for the Demand measure at S210. Analytical engine 120 supports the following types of filters according to some embodiments:
global fix filters (SF): global restrictions on dimensions defined in the query definition
dynamic filters (SD): global restrictions on dimensions defined during the query runtime
filter according to the dimensions in drill down (SA) to restrict cells to individual values of the dimensions
filter (S1) based on first structure (if defined), to restrict cells according to elements of the first structure
filter (S2) based on second structures (if defined), to restrict cells according to elements of the first structure
filter (SC) for exception cells (if defined), omitting (S1) and (S2).

The filters may contain a restriction to a certain time value tᵣ of T_{SC}. To calculate the stock coverage of a cell, the demand is needed for tᵣ as well as for later time values tᵣ₊ᵢ. To obtain demand values outside the time filter of a cell, the filters on (total and partial) time dimensions are suppressed or modified for the Demand measure of a Stock Coverage measure.

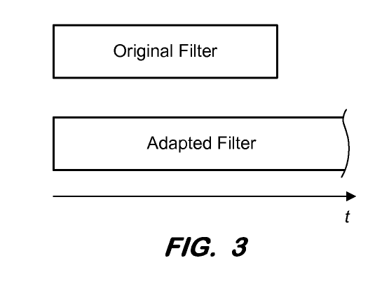

Filters on time dimensions which are defined as a global fix filter (SF), dynamic filter (SD) or drill down dimension (SA) are suppressed by a “constant selection” on the time dimension. Filters defined in a structure element (S1 and S2) or in an exception cell (SC) are adapted for the Demand measure. As depicted in FIG. 3, filters on a coherent range of time values for a total time dimension are changed to filter all time values greater than or equal to the minimum of the original filter. Other filters on time dimensions are removed.

According to some embodiments, the constant selection and the filters for the Demand measure are created implicitly by analytical engine 120 at S220 without user interaction.

Next, at S220, individual demand values for each value of the time dimension are retrieved. For example, analytical engine 120 aggregates all operands up to the granularity based on which a formula is calculated. Therefore, there is exactly one value for each operand of the formula for each dimension value combination of the granularity based on which the formula is calculated. To calculate the stock coverage, individual demand values are needed for each value of T_{SC} to execute the stock coverage calculation described above.

Accordingly, instead of one demand value per cell, a vector of demand values grouped by T_{SC} is needed per cell. Analytical engine 120 may define, for each measure, dimensions which are kept in the “group by” clause when reading the data from database 110. When the data is aggregated according to the aggregation steps mentioned above, the individual process steps aggregate over these characteristics and removes them from the group by clause. One example is the exception aggregation reference dimension, in that the exception aggregation aggregates over the exception aggregation reference dimension and takes it out of the group by clause.

Similarly, the time dimension T_{SC} is inserted into the group by clause for the Demand measure at S230 to get individual demand values per value of T_{SC}.

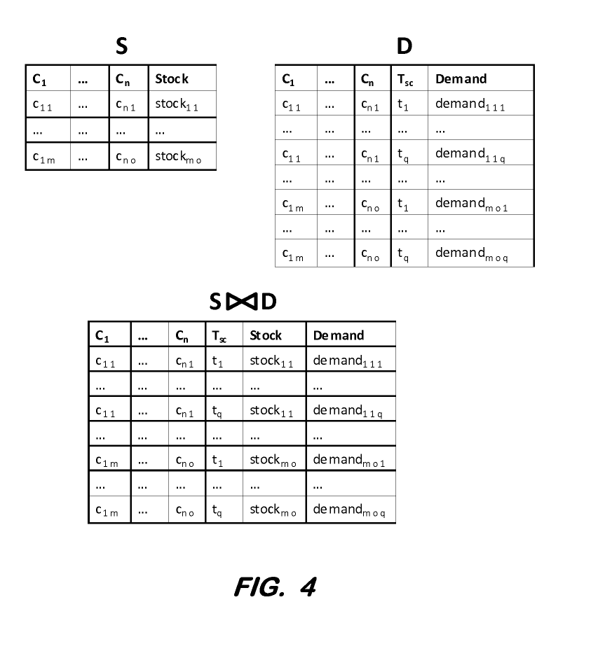

A table is generated at S240. The table includes, for each stock value, all demand values which may be used to calculate the Stock Coverage measure. From a relational point of view, a stock coverage value is calculated for each value combination of the dimensions C₁ to Cₙ needed for further processing of the stock coverage measure. The input data of the stock coverage calculation is placed in two tables. One table S contains the stock as depicted in FIG. 4. The key of table S are the dimensions C₁ to Cₙ. The second table D of FIG. 4 contains the demand. The key of table D are the dimensions C₁ to Cₙ plus the time dimension T_{SC}. The stock coverage calculation does a 1:n join on the dimensions C₁ to Cₙ of the tables S and D to obtain, for each stock value, all demand values which are potentially considered by the stock coverage calculation. The resulting table is also shown in FIG. 4.

Analytical engine 120 may store the input data for the calculation of the cell values in a table hereinafter called SP. The SP table contains one line for each dimension value combination of the dimensions in drill down of the subtotal level. Each line of the SP table contains all input data to calculate the cells of the dimension value combination. If a certain input measure is needed not only once for a SP line, but multiple times grouped by one or multiple dimensions, then this input measure is stored in a table within the SP line. The dimensions of the group by clause are key fields of this table. Examples for such dimensions are the exception aggregation reference dimensions in case an exception aggregation is defined for a measure or the time dimension T_{SC} in case of a demand measure for a stock coverage calculation.

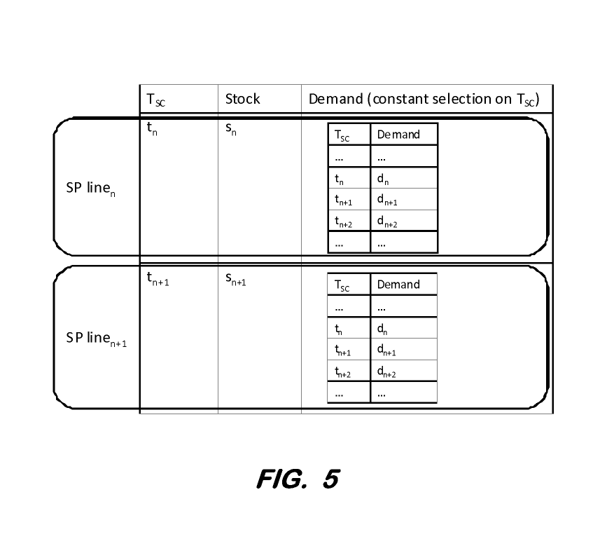

FIG. 5 below shows two lines of an SP table according to some embodiments. The time dimension T_{SC} is the only dimension in drill down of the subtotal level and the query contains only one stock coverage measure. The question may arise of whether memory is inefficiently used by storing the same table of demand values within each SP line.

As described above, a constant selection is defined on the dimension T_{SC} for the Demand measure to ignore the drill down by this dimension. Analytical engine 120 may determine the data for the final SP table with several read requests to database 110. The result of a single read request is stored in a partition, thereby making the partition a data object for subsets of the final SP table. After all read requests are processed, the data is merged into the final SP table used for the calculation of the cells by performing a union operation in analytical engine 120.

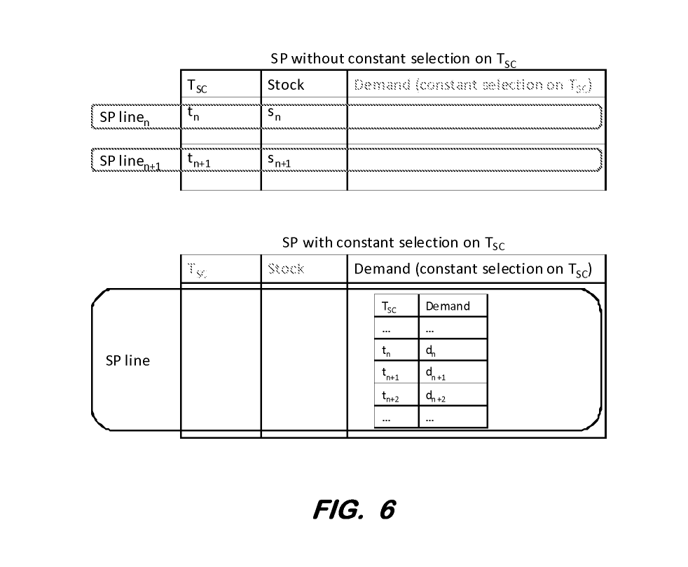

Each partition contains an SP table in which only the fields relevant for the partition are populated. One reason to have multiple read requests/partitions is the constant selection. In case of a constant selection, the stored data isn't grouped by the constant selection dimension(s) in the SP table of the partition, because the data is the same for all values of the constant selection dimension(s). For the present example, this means that two partitions/SPs are created, one for the partition/SP without constant selection and one for the partiton/SP with constant selection. FIG. 6 illustrates lines of each of these partitions according to the present example.

When analytical engine 120 merges these two partitions/SPs, the relevant fields of each SP table are copied to the resulting final SP table considering the constant selection. When the table of demand values is copied to multiple SP tables lines, a memory manager may copy only a reference to the table instead of the table. Accordingly, only memory for a reference needs to be allocated, rather than memory for a table. The memory manager may physically copy the table lazy/late when the table is modified. Consequently, the memory for the identical demand tables in the two SPs lines of the final SP table and the single line in the SP table with constant selection is allocated only once.

A unique time value t_{S} of T_{SC} is needed for each stock value in order to derive the time value t_{DF} of the first demand to be considered. Therefore, t_{S} needs to be determined for each value combination of the dimensions C₁ to Cₙ. If T_{SC} is one of the dimensions C₁ to Cₙ defining the group by of the stock data processed by the stock coverage calculation, then t_{S} is clearly defined. But this is only the case if T_{SC} is in the drill down of the subtotal level or is an exception aggregation reference dimension of the formula exception aggregation. The stock coverage should also be calculated for subtotal levels without T_{SC} in drill down.

Time dimension T_{SC} is defined as the exception aggregation reference for stock coverage measures in order to determine t_{S} for each value combination of the dimensions C₁ to Cₙ. As already mentioned, this exception aggregation is executed as a formula exception aggregation, because the regular exception aggregation is done before the stock coverage calculation. Since the exception aggregation reference dimension (i.e., T_{SC}) is also used as time dimension T_{SC} defining the granularity of the stock coverage, T_{SC} is always in the group by clause as exception aggregation reference dimension of the formula exception aggregation when the stock coverage calculation is applied.

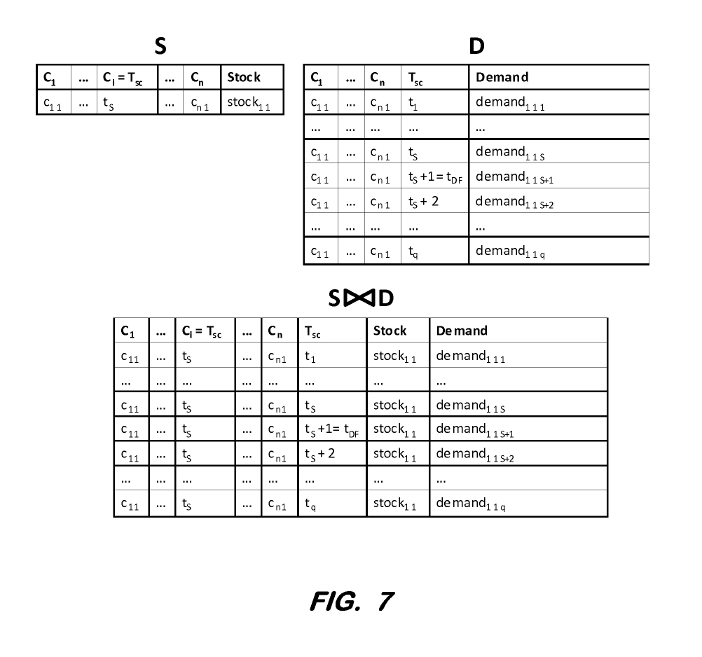

FIG. 7 shows the join of the stock and demand values for one value combination, where one dimension Cᵢ of the dimensions C₁ to is T_{SC}. The dimension Cᵢ isn't part of the demand table and the dimensions compared by the join. The time value t_{DF} of the first demand to be considered is shown for a stock at the end of a period. The stock_{1 1} and potentially the demands from demand_{1 1 S+1} to demand_{1 1 q} are considered during the calculation of the stock coverage for the given value combination of C₁ to Cₙ.

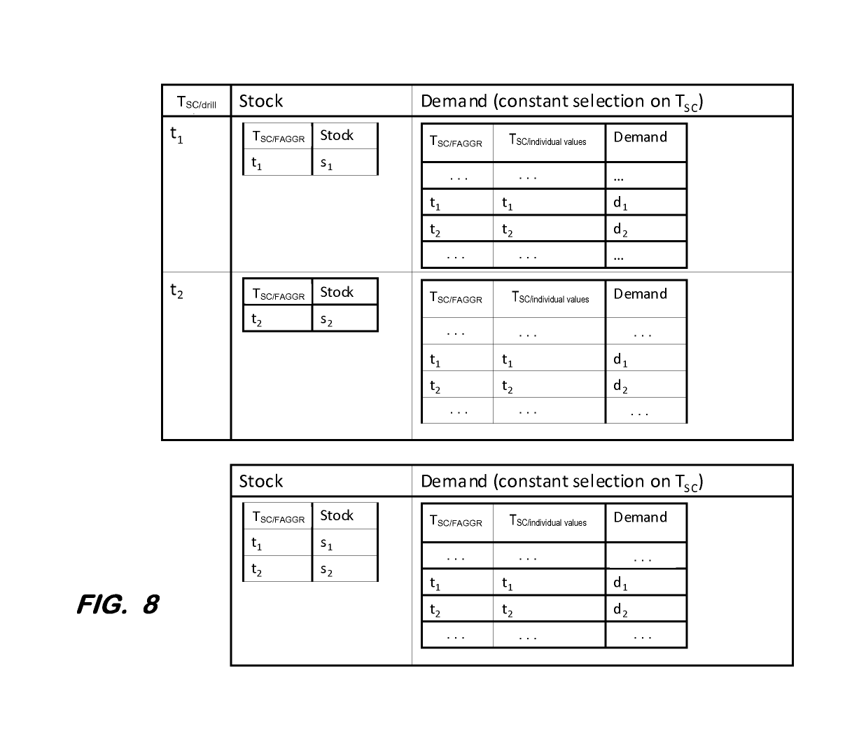

For clarity, T_{SC} isn't shown as an exception aggregation reference dimension of formula exception aggregation in the example SP lines of FIG. 5. FIG. 8 presents a more complete example, with one SP for a subtotal level with T_{SC} in drill down and one SP for a subtotal level without T_{SC} in drill down.

As shown in FIG. 8, T_{SC} can be in group by clause three times for different reasons. First, in T_{SC/drill} as a dimension which is in drill down because of the current subtotal level (Stock Coverage, Stock and Demand measure), second, in T_{SC/FAGGR} as an exception aggregation reference dimension of formula exception aggregation (Stock Coverage, Stock and Demand measure) and third, in T_{SC/individual values} to retrieve individual demand values per value of T_{SC} (Demand measure only).

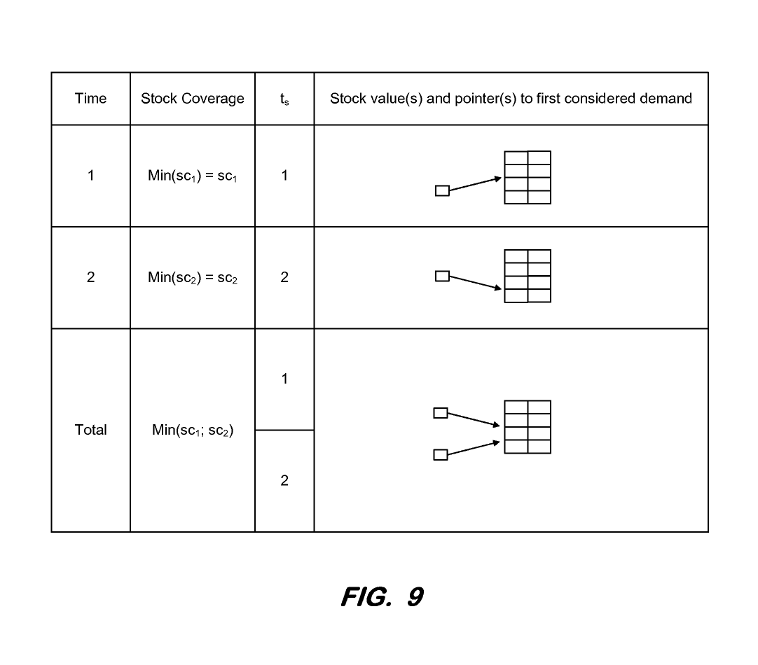

The stock coverage is determined at S250 based on the table generated at S230 and on the formula exception aggregation. FIG. 9 illustrates the stock coverage calculation with exception aggregation minimum. Determination of the stock coverage value on (sub-)total levels without T_{SC} in drill down by an exception aggregation is logical from a business point of view. Given the scenario that the T_{SC} is calendar day and the exception aggregation of the Stock Coverage measure is minimum, the stock coverage will always show the minimum stock coverage value of days in the time range of a cell.

According to some embodiments, if a fixed unit is defined for the Stock Coverage measure as described above, analytical engine 120 sets this unit for all stock coverage values. In case a query contains a unit conversion applied on the Stock Coverage measure, the stock coverage values are converted according to the unit conversion and the units of the stock coverage values are set to the target unit of the unit conversion.

If the stock value and the demand values considered during the calculation of one stock coverage value have no unique currency or unit, the resulting stock coverage value is marked as a value with mixed currency or unit (even if no fixed unit is defined for the Stock Coverage measure). A user is then able to recognize that the stock coverage value is not meaningful and can define a currency or unit conversion for the Stock Coverage measure. Currency and unit conversions affecting a Stock Coverage measure are propagated to the corresponding Stock and Demand measures. The currency or unit of the Stock and Demand measures is then converted before the stock coverage calculation to a unique currency or unit and a meaningful stock coverage value can be calculated.

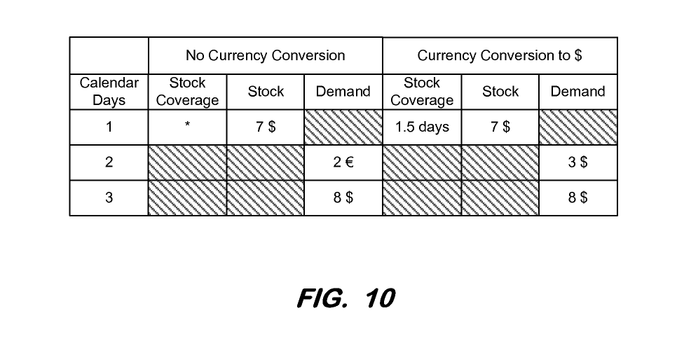

FIG. 10 illustrates a query result with a structure containing two elements and where a stock coverage calculation over measures with currencies occurred (e.g., to calculate the coverage of liquid funds). No currency conversion is defined for the first structure element, so analytical engine 120 marks (e.g., using ‘*’) the stock coverage values as values with mixed currency or unit. A currency conversion is defined for the second structure element, which ensures that all stock and demand values processed by the stock coverage calculation represent the same currency. Cells which are not relevant are grayed out in the query result.

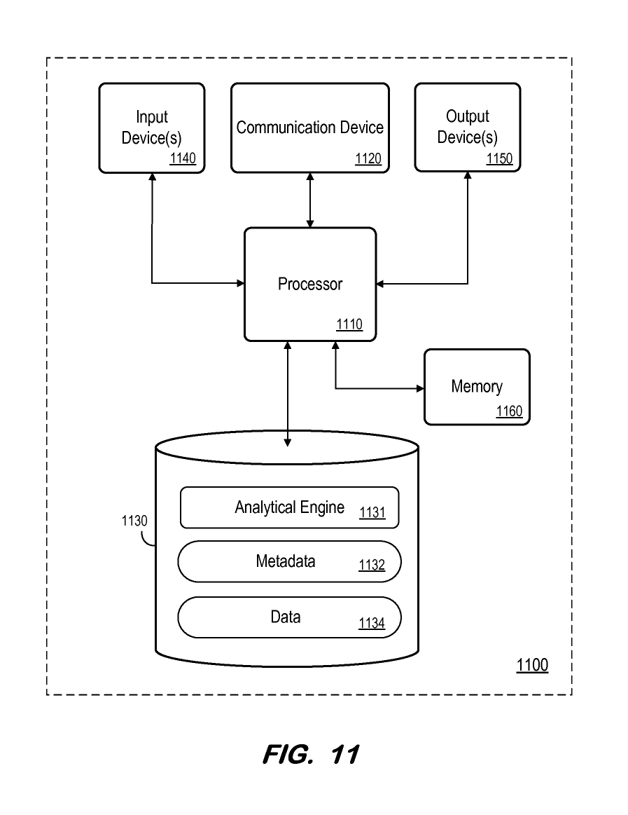

FIG. 11 is a block diagram of system 1100 according to some embodiments. System 1100 may comprise a general-purpose computing system and may execute program code to perform any of the processes described herein, including but not limited to process 200. System 1100 may comprise an implementation of database 110, and may include other unshown elements according to some embodiments.

System 1100 includes processor 1110 operatively coupled to communication device 1120, data storage device 1130, one or more input devices 1140, one or more output devices 1150 and memory 1160. Communication device 1120 may facilitate communication with external devices, such as a reporting client, or a data storage device. Input device(s) 1140 may comprise, for example, a keyboard, a keypad, a mouse or other pointing device, a microphone, knob or a switch, an infra-red (IR) port, a docking station, and/or a touch screen. Input device(s) 1140 may be used, for example, to enter information into apparatus 1100. Output device(s) 1150 may comprise, for example, a display (e.g., a display screen) a speaker, and/or a printer.

Data storage device 1130 may comprise any appropriate persistent storage device, including combinations of magnetic storage devices (e.g., magnetic tape, hard disk drives and flash memory), optical storage devices, Read Only Memory (ROM) devices, etc., while memory 1160 may comprise Random Access Memory (RAM).

Analytical engine 1131 may comprise processor-executable program code executable by processor 1110 to cause system to operate as described herein. Metadata 1132 and data 1134 may respectively implement metadata 112 and data 114 as described above. As also described above, metadata 1132 and data 1134 may be implemented in volatile memory such as memory 1160. Data storage device 1130 may also store data and other program code for providing additional functionality and/or which are necessary for operation of system 1100, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of database 110 or analytical engine 120 may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those skilled in the art will recognize other embodiments may be practiced with modifications and alterations to that described above.

What is claimed is:

1. A computing system comprising:
a data storage device;
a memory storing processor-executable program code; and
a processor to execute the processor-executable program code in order to cause the computing system to:
define a time dimension as a formula exception aggregation reference dimension of a stock coverage measure;
modify filters of a demand measure to retrieve demand values outside a time filter of a cell;
retrieve individual values of the demand measure for each value of the time dimension;
generate a table comprising, for each value of a stock measure, values of the demand measure needed to calculate the stock coverage measure; and
determine the stock coverage measure based on the table and on the formula exception aggregation.

2. A computing system according to claim 1, wherein generation of the table comprises:
determination of a first table comprising each value of the stock measure, the first key of the first table comprising dimensions C₁ through Cₙ;
determination of a second table comprising individual values of the demand measure for each value of a time dimension, the second key of the second table comprising dimensions C₁ through Cₙ and the time dimension; and
execution of a 1:n join on the dimensions C₁ through Cₙ of the first table and the second table.

3. A computing system according to claim 2, wherein modification of filters of a demand measure comprises:
changing of a first filter on a coherent range of time values to a second filter on all time values greater to or equal than the earliest of the coherent range of time values.

4. A computing system according to claim 1, wherein modification of filters of a demand measure comprises:
changing of a first filter on a coherent range of time values to a second filter on all time values greater to or equal than the earliest of the coherent range of time values.

5. A non-transitory computer-readable medium storing program code, the program code executable by a processor of a computing system to cause the computing system to:
define a time dimension as a formula exception aggregation reference dimension of a stock coverage measure;
modify filters of a demand measure to retrieve demand values outside a time filter of a cell;
retrieve individual values of the demand measure for each value of the time dimension;
generate a table comprising, for each value of a stock measure, values of the demand measure needed to calculate the stock coverage measure; and
determine the stock coverage measure based on the table and on the formula exception aggregation.

6. A non-transitory computer-readable medium according to claim 5, wherein generation of the table comprises:
determination of a first table comprising each value of the stock measure, the first key of the first table comprising dimensions C₁ through Cₙ;
determination of a second table comprising individual values of the demand measure for each value of a time dimension, the second key of the second table comprising dimensions C₁ through Cₙ and the time dimension; and
execution of a 1:n join on the dimensions C₁ through Cₙ of the first table and the second table.

7. A non-transitory computer-readable medium according to claim 6, wherein modification of filters of a demand measure comprises:
changing of a first filter on a coherent range of time values to a second filter on all time values greater to or equal than the earliest of the coherent range of time values.

8. A non-transitory computer-readable medium according to claim 5, wherein modification of filters of a demand measure comprises:
changing of a first filter on a coherent range of time values to a second filter on all time values greater to or equal than the earliest of the coherent range of time values.

9. A computer-implemented method comprising:
defining a time dimension as a formula exception aggregation reference dimension of a stock coverage measure;
modifying filters of a demand measure to retrieve demand values outside a time filter of a cell;
retrieving individual values of the demand measure for each value of the time dimension;
generating a table comprising, for each value of a stock measure, values of the demand measure needed to calculate the stock coverage measure; and
determining the stock coverage measure based on the table and on the formula exception aggregation.

10. A computer-implemented method according to claim 9, wherein generating the table comprises:
determining a first table comprising each value of the stock measure, the first key of the first table comprising dimensions C₁ through Cₙ;
determining a second table comprising individual values of the demand measure for each value of a time dimension, the second key of the second table comprising dimensions C₁ through Cₙ and the time dimension; and
executing a 1:n join on the dimensions C₁ through Cₙ of the first table and the second table.

11. A computer-implemented method according to claim 10, wherein modifying filters of a demand measure comprises:
changing a first filter on a coherent range of time values to a second filter on all time values greater to or equal than the earliest of the coherent range of time values.

12. A computer-implemented method according to claim 9, wherein modifying filters of a demand measure comprises:
changing a first filter on a coherent range of time values to a second filter on all time values greater to or equal than the earliest of the coherent range of time values.
